(19) United States
(12) Patent Application Publication
(10) Pub. No.: US 2026/0161395 A1
(43) Pub. Date: Jun. 11, 2026

(54) SYSTEM AND METHOD FOR PERFORMING AI TASKS

(71) Applicant: EvoChip Inc., Dana Point, CA (US)

(72) Inventor: PATRICK O'NEILL, Dana Point, CA (US)

(73) Assignee: EvoChip Inc., Dana Point, CA (US)

(21) Appl. No.: 18/976,019

(22) Filed: Dec. 10, 2024

(51) Int. Cl. G06F 9/30

(52) U.S. Cl. CPC G06F 9/30007

(57) ABSTRACT

Systems and methods including one or more processors and one or more non-transitory storage devices storing computing instructions configured to run on the one or more processors and perform acts of receiving one or more input values from an algorithm implementing a predictive algorithm; converting each input value of the one or more input values into a bitwise representation of the input; storing the bitwise representation of the input value in a register; performing one or more bitwise operations on the bitwise representation of the input value to create a bitwise output; converting the bitwise output into one or more output values; facilitating training the predictive algorithm using the one or more output values; and facilitating using the trained predictive algorithm to make a prediction. Other embodiments are disclosed herein.

### TECHNICAL FIELD

This disclosure generally relates to performing artificial intelligence (AI) tasks, and more specifically, to systems and methods for decreasing the computing power and/or time for training models that underly AI systems.

### BACKGROUND

Running an AI system is a processor intensive endeavor due to the large amount of mathematics performed by the underlying probabilistic models. For example, matrix multiplication performed using floating point mathematics can consume an inordinate amount of a processor's resources (e.g., transistors) when implementing a neural network. This processing burden can be further compounded when one or more techniques are implemented that rely heavily on matrix multiplication (e.g., one or more of backpropagation, gradient descent, principal component analysis, convolutional neural networks, and/or Markov Models). Further, due to the fact that the number of multiplications performed can increase exponentially as a number of input variables (e.g., tokens) is increased, the processing burdens for training larger models (e.g., large language models (LLMs) such as ChatGPT or Bard) can quickly become overwhelming for standard systems, such that the systems become slow and prone to errors. Therefore, a need exists for a system and method that accelerates the development of AI systems by decreasing the computing power and/or time for training probabilistic models that underly such AI systems.

### SUMMARY

Various embodiments can include a system. The system can include one or more processors and one or more non-transitory computer-readable storage devices. The one or more non-transitory computer-readable storage devices can store computing instructions. The computing instructions can be configured to communicate with the one or more processors and cause the one or more processors to perform receiving one or more input values from an algorithm implementing a predictive algorithm; converting each input value of the one or more input values into a bitwise representation of the input; storing the bitwise representation of the input value in a register; performing one or more bitwise operations on the bitwise representation of the input value to create a bitwise output; converting the bitwise output into one or more output values; facilitating training the predictive algorithm using the one or more output values; and facilitating using the trained predictive algorithm to make a prediction.

Various embodiments include a method. The method can be implemented via execution of computing instructions configured to run at one or more processors and/or configured to be stored at non-transitory computer-readable media The method can comprise receiving one or more input values from an algorithm implementing a predictive algorithm; converting each input value of the one or more input values into a bitwise representation of the input; storing the bitwise representation of the input value in a register; performing one or more bitwise operations on the bitwise representation of the input value to create a bitwise output; converting the bitwise output into one or more output values; facilitating training the predictive algorithm using the one or more output values; and facilitating using the trained predictive algorithm to make a prediction.

Various embodiments can include an application specific integrated circuit (ASIC) for training a predictive algorithm. The ASIC can comprise one or more registers for storing one or more bitwise representations generated from one or more values received from an algorithm implementing the predictive algorithm, wherein the one or more bitwise representations are generated from the one or more values; one or more operators for implementing one or more bitwise operations configured to create one or more bitwise outputs; and one or more attenuators configured to modulate an influence of the one or more bitwise operations.

### BRIEF DESCRIPTION OF THE DRAWINGS

To facilitate further description of the embodiments, the following drawings are provided:

FIG. 1 illustrates a flowchart for an exemplary method, according to various embodiments.

FIG. 2 illustrates a block diagram of an exemplary system for performing AI tasks, according to various embodiments.

FIG. 3 illustrates a block diagram of an exemplary system for an operator, according to various embodiments.

FIG. 4 illustrates a block diagram of an exemplary computer system, according to various embodiments.

### DETAILED DESCRIPTION

From a broad perspective, modern AI systems are an implementation of one or more algorithms that use mathematics to predict a most likely outcome. For example, conversational generative AI systems (e.g., LLMs) most likely generate text output for a given text input using a variety of math based algorithms (e.g., autoregressive models, attention mechanisms, SoftMax functions, Sequence-to-Sequence models, backpropagations, etc.). Many of these algorithms use matrix multiplication to aid in generating predictions. Matrix multiplication can be a processor-intensive computational procedure due to the number of operations required to compute a product of two matrices. This is because the number of operations performed grows cubically with matrix size, and therefore tokens are used in a prediction. The nature of how data is handled at the hardware level also cause matrix multiplication to be demanding on processors. This is because matrix multiplication often involves floating-point arithmetic. Floating-point arithmetic operations often use more processing resources than integer arithmetic operations due to the complexity involved in the handling the precision, rounding, and normalization involved in floating-point arithmetic. This complexity causes matrix multiplication to be slower when large amounts of floating-point data are processed, which is common in AI systems.

Many of the above processor burdening problems with AI systems could be resolved by avoiding or minimizing the use of floating point arithmetic. Floating-point arithmetic is a way to represent and perform calculations on real numbers in computers and is often used for representing very large or very small numbers that cannot be efficiently stored using fixed-point or integer representations. Similar to scientific notation, floating point numbers can be represented by a sign, an exponent, and a mantissa, and are often expressed as:

$${( - 1 )}^{s i g n} \times mantissa \times {2}^{exponent} .$$

In systems where floating point arithmetic is used, different numbers of bits can be used for the sign, exponent, and mantissa. These floating point numbers can then be added, subtracted, multiplied, or divided much like other real numbers. On the other hand, bitwise operators (e.g., AND, OR, XOR, NOR, NAND, NOR, shift left, shift right, etc.) are efficient at performing bit level operations due to their simplicity without the need for floating point arithmetic. For example, logic gates used by bitwise operators can be faster due to a size of the computational circuits of the logic gates. Due to the smaller circuit, propagation delay can be smaller than a system clock period. As such, bitwise operators can produce results during each clock cycle. For example, a bitwise operator that takes 2 inputs can produce a result on a next clock cycle.

In various embodiments, the techniques described herein can provide a practical application and several technological improvements. For example, the techniques described herein can provide for faster training and implementation of AI systems. This provides a significant improvement over conventional approaches of training an implementation (e.g., using floating point arithmetic for implementation and training) by decreasing a number of transistors needed for a similar calculation (thereby decreasing the burdens of processors performing the implementation and training). In various embodiments, the techniques described herein can solve a technical problem that arises only within the realm of computer networks, as bitwise operators do not exist outside the realm of computer networks.

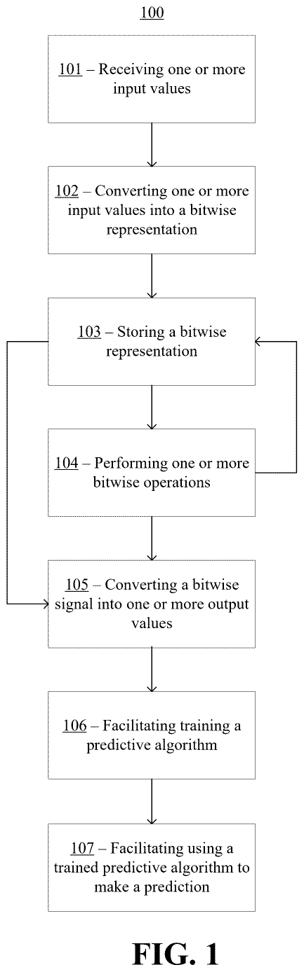

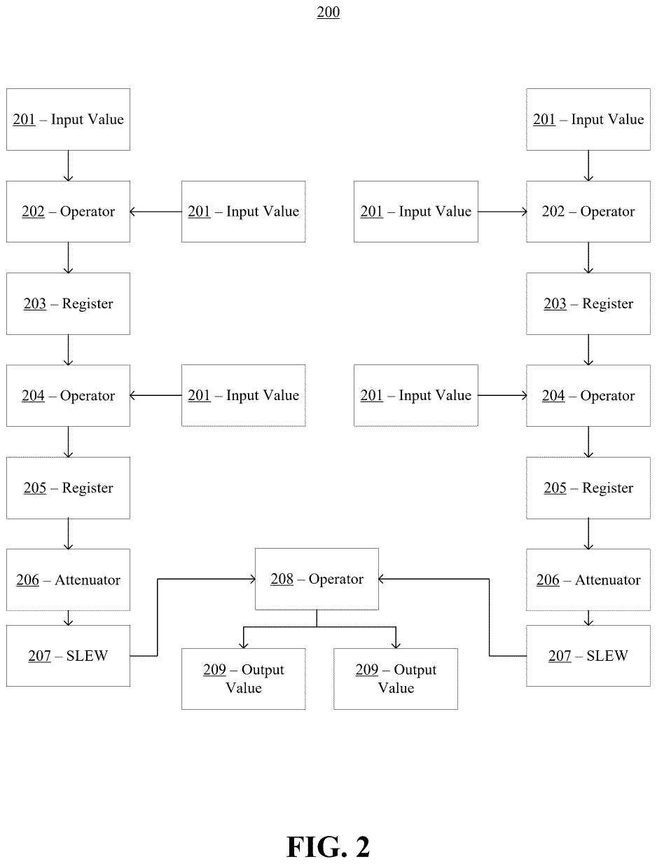

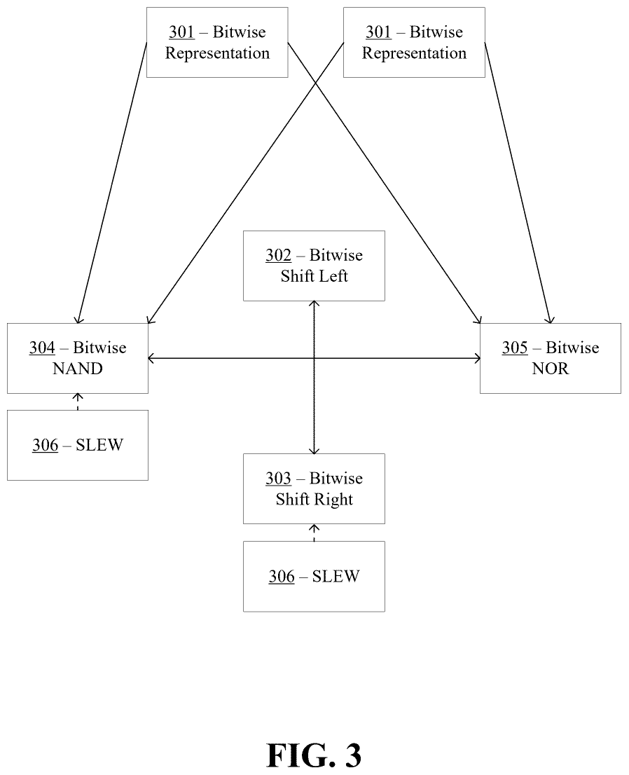

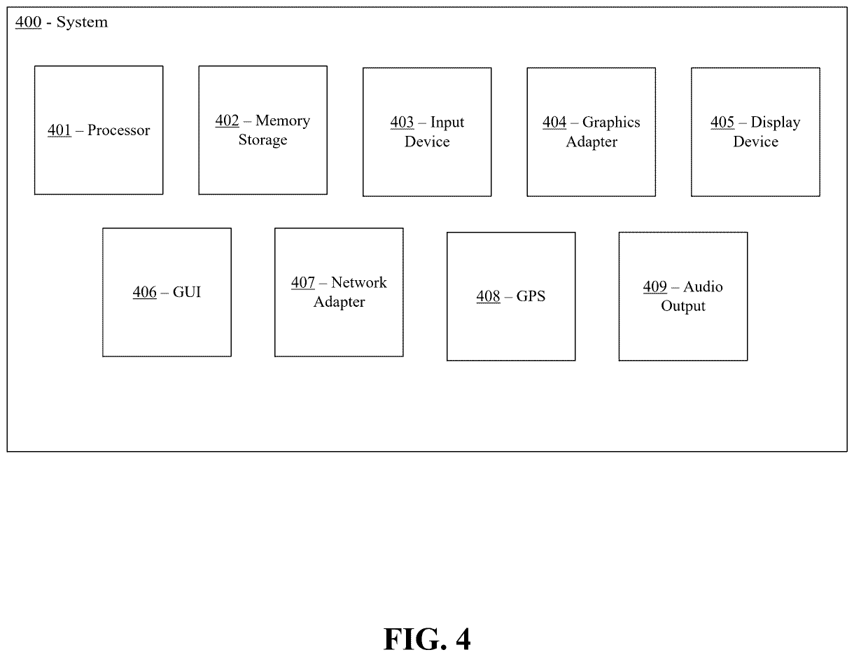

FIG. 1 illustrates a flow chart for an exemplary method 100, according to various embodiments. Method 100 can be employed in many different embodiments or examples not specifically depicted or described herein. In various embodiments, the activities of method 100 can be performed in the order presented, in any suitable order and one or more of the activities of method 100 can be combined or skipped. In various embodiments, system 200 (FIG. 2), system 300 (FIG. 3), or system 400 (FIG. 4) can be suitable to perform method 100 and/or one or more of the activities of method 100. In various embodiments, one or more of the activities of method 100 can be implemented as one or more computer instructions configured to run at one or more processing modules and configured to be stored at one or more non-transitory memory storage modules. Such non-transitory memory storage modules can be part of a computer system such as system 400 (FIG. 4). The processing module(s) can be similar or identical to the processing module(s) described above with respect to computer system 400 (FIG. 4).

In various embodiments, method 100 may comprise an activity 101 of receiving one or more input values. In many embodiments, input values can comprise numbers in a variety of base systems. For example, an input value can comprise a binary (e.g., base two) number. As another example, an input value can comprise a hexadecimal (e.g., base 16) number. Using different based numbering systems can allow an AI accelerator system to maximize an amount of values that can be fed into one or more processors with a lowered bus size and/or memory bandwidth. In this way, lower powered processors can be used to accomplish the training and use of AI algorithms. In some embodiments, input values can comprise a non-integer value. Non-integer values can comprise a real number with an integer portion that occurs before a decimal point and a fractional portion that occurs after a decimal point. In various embodiments, a fractional portion can also be expressed as a For example, the number 3.048 has an integer portion of “3” and a fractional portion of “048.” Input values can be received from a number of different sources. For example, input values can be received from a predictive algorithm and/or one or more sub-algorithms that comprise and/or implement the predictive algorithm. A predictive algorithm can be understood as any algorithm configured to output a prediction when given an input (e.g., statistics based algorithms). For example, a predictive algorithm can comprise a binary classification algorithm configured to predict a class, grouping, and/or label to apply to an input. It will be understood that multiple predictive algorithms can be joined together to generate more complex predictions. For example, an LLM can be understood as a conglomeration of multiple predictive algorithms that generates a more complex prediction (e.g., a text based response to a text based chat).

Turning now to FIG. 2, a block diagram of a system 200 is shown that can be employed for AI acceleration. System 200 is merely exemplary and embodiments of the system are not limited to the embodiments presented herein. System 200 can be employed in many different embodiments or examples not specifically depicted or described herein. In various embodiments, certain elements or modules of system 200 can perform various procedures, processes, and/or activities. In various embodiments, the procedures, processes, and/or activities can be performed by other suitable elements or modules of system 200. Generally speaking, system 200 can be implemented with hardware and/or software. Part or all of the hardware and/or software implemented in system 200 can be conventional or part or all of the hardware and/or software can be customized (e.g., optimized) for implementing part or all of the functionality of system 200 described herein. As can be seen in FIG. 2, a plurality of input values 201 can be received in an AI acceleration system 200. While the plurality of input values 201 are all shown as similar in FIG. 2, it should be understood that each input value 201 can have different values and/or be received from different sources. For example, a first input value 201 can be received from a first sub-algorithm in a predictive algorithm, a second input value 201 can be received from a second sub-algorithm in a predictive algorithm, etc.

Returning now to FIG. 1, method 100 can comprise an activity 102 of converting one or more input values into a bitwise representation. In many embodiments, activity 102 can be performed without using floating point mathematics. In various embodiments, activity 102 can be performed using fixed-point mathematics. A bitwise representation of an input value can be created by identifying an integer portion of a input value and a fractional portion of the input value (if one is present). The integer portion and the fractional portion can then each be converted into a binary notation for the specific portion. For example, the number 3.048 can be split into an integer portion of “3” and a fractional portion of “048.” The integer portion can then be converted into 0011 (the binary representation of the number 3) and the fractional portion can then be converted into 0001 1000 1001 0011 0111. A binary representation of a fractional portion can be calculated as a rational number with a denominator equal to 2 to the power of a number of bits used for the fractional portion. A numerator of the rational number can be determined by setting this rational number as equal to the fractional portion. To continue with the example from above, the fractional portion can be determined by taking 2\hat{ }21 (0x1FFFFF in hexadecimal and 2097152 in decimal). To find a numerator, the denominator can be multiplied by 0.048 to generate 100663.296 (truncated in hexadecimal to 0x18937), which generates a binary fractional portion of 0001 1000 1001 0011 0111. Truncation can allow fractional portions and/or integer portions to be stored using limited bits available on an AI acceleration chip while still allowing for an accurate estimation. In various embodiments, a bitwise representation can comprise 25 bits of information. For example, 4 bits can be used to represent an integer portion and 21 bits can be used to represent a fractional portion. When stored as a string, a bitwise representation can begin with a representation of an integer portion and then end with a representation of a decimal portion.

In various embodiments, method 100 can comprise an activity 103 of storing a bitwise representation. A bitwise representation can be stored in a number of different locations in a computer system. For example, a bitwise representation can be stored in one or more registers of one or more processors. A processor register can comprise a quickly accessible storage location available on a processor. Computer systems generally load items of data from a larger memory into registers. Once loaded, data in the register (e.g., a bitwise representation) can be used for arithmetic operations, bitwise operations, and/or other computer operations. Activity 103 can also be performed again after activity 104. Returning now to FIG. 2, it can be seen that a bitwise representation can be stored in a register at a number of different points. For example, a bitwise output of one or more operators 202, 204 can be stored in a register before being passed to a different aspect of an AI accelerator system.

In various embodiments, method 100 can comprise an activity 104 of performing one or more bitwise operations on a bitwise representation to create a bitwise output. A bitwise operation can comprise operations that directly manipulate individual bits within a binary representation of a number (e.g., a bitwise representation). a number of different bitwise operators can be used in activity 104. For example, a bitwise NAND, a bitwise NOR, a bitwise shift left, and/or a bitwise shift right can be used. NAND, NOR, shift left, and shift right can be particularly useful in an AI accelerator system for a number of reasons. For example, these operators faster than other operators due to their simplicity. As another example, NAND and NOR are well known for their flexibility, and are often referred to as the two universal logic gates. A universal logic gate may include a logic gate that can be used to create other logic gates. For example, an AND gate can be created out of only NAND gates by using a first NAND gate to perform an AND operation with a result negated. A second NAND gate can then be used to invert the negation. As another example, an AND gate can be created out of only NOR gates. The process may include creating a NOT gate by connecting both inputs of a NOR gate to the same signal. The process may also include creating an OR gate by negating an output of a NOR gate using another NOR gate. The process may further include combining the NOT of the OR gate to get the AND gate. Other processes can be used to create OR NOT, XOR, and all other gates.

Bitwise NAND can comprise an operation that combines two binary numbers (e.g., two bitwise representations) by using the NAND logic on each corresponding pair of bits. Bitwise NAND can first perform a bitwise AND on the numbers, and then inverts the result by applying the NOT operation. When the corresponding bits of two numbers are compared using the AND operation, a 1 will be returned when both bits are 1; otherwise, the AND operation returns 0. When applying a NOT operation, each 0 becomes a 1 and each 1 becomes a 0. Bitwise NOR can comprise an operation that applies the NOR (NOT OR) logic to each pair of corresponding bits from two binary numbers (e.g., two bitwise representations). Bitwise NOR first performs a bitwise OR operation, and then inverts the result by applying the NOT operation. When the corresponding bits of two numbers are compared using the OR operation, a 1 will be returned when at least one bit is 1; otherwise, the OR operation returns 0. When applying a NOT operation, each 0 becomes a 1 and each 1 becomes a 0. Bitwise shift left is a bitwise operation that shifts bits of a binary number (e.g., a bitwise representation) to the left by a specified number of positions. Each shift can move bits one position to the left, and new bits (zeros) are filled in from the right. The leftmost bits (those that exceed the number's bit length) are discarded. Bitwise shift right is a bitwise operation that shifts bits of a binary number (e.g., a bitwise representation) to the right by a specified number of positions. Each shift can move bits one position to the right, and new bits (zeros) are filled in from the left. The leftmost bits (those that exceed the number's bit length) are discarded.

Returning now to FIG. 2, a number of operators can be used in AI accelerator system 200 in sequence or in series. One or more input values can be input into operator 202, while bitwise representations stored in registers 203, 205 can be input into operator 204. Operator 208 can also be used before generating an output value 209 before a training sequence begins.

Turning now to FIG. 3, a block diagram of an operator system 300 (e.g., one or more of operators 202 (FIG. 2), 204 (FIG. 2), 206 (FIG. 2), and/or 208 (FIG. 2)) is shown. Operator 300 is merely exemplary and embodiments of the system are not limited to the embodiments presented herein. Operator 300 can be employed in many different embodiments or examples not specifically depicted or described herein. In various embodiments, certain elements or modules of operator 300 can perform various procedures, processes, and/or activities. In these or other embodiments, the procedures, processes, and/or activities can be performed by other suitable elements or modules of operator 300. Generally speaking, operator 300 can be implemented with hardware and/or software. Part or all of the hardware and/or software implemented in operator 300 can be conventional or part or all of the hardware and/or software can be customized (e.g., optimized) for implementing part or all of the functionality of operator 300 described herein. In various embodiments, operator 300 can begin by performing one or more of bitwise NAND operation 304 and/or bitwise NOR operation 305 on one or more bitwise representations 301. The operated on bitwise representation can then be sequentially operated on by one or more of bitwise NAND 304, bitwise NOR 305, bitwise shift left 302, and/or bitwise shift right 303 according to parameters coded into one or more of SLEW 306. While SLEW 306 is shown in FIG. 3 as influencing an operation of bitwise NAND 304 and/or bitwise shift right 303, it should be understood that SLEW 306 can also be used to influence an operation of bitwise shift left 302 and/or bitwise NOR 305. SLEW 306 can be understood as modulating a power of a bitwise operator it influences. SLEW 306 can comprise a function that provides a transition between two or more bitwise representations with or without a control scalar. When present, a scalar can take a real value in a range of [0,1]. When SLEW 306 uses a scalar value of 0, one of the input values is output. When SLEW 306 uses a scalar value of 1, a second input value is output. When SLEW 306 uses a scalar value between 0 and 1, a bit pattern is generated. The closer to 0, the closer an output relates to the first input. The closer to 1, the closer an output relates to the second input. In other words, SLEW 306 can operate as a bitwise analog of interpolation between two points.

A number of different functions and implementations can be used in SLEW 306, and indeed the implementation has several different supported options for this function. For example, linear interpolation of integers can be used. In a more specific example, a single integer multiply-add instruction can be used. Numerators in the linear interpolation can be powers of 2 and division can be performed using a bit shift (e.g., bitwise shift left and/or bitwise shift right). As another example, a combination of bit shifts and bit pattern matching algorithms can be used in SLEW 306. These bit shifts and/or bit pattern matching algorithms can take one or more input bit sequences being interpolated between two numbers (e.g., 0 and 1), and break the bit sequences into smaller portions of 2 to five bits at a time.

Returning now to FIG. 1, In various embodiments, activity 104 can further comprise modulating an influence of the one or more bitwise operations using an attenuator. An attenuator (e.g., attenuator 206 (FIG. 2) is a mechanism, technique, and/or algorithm used to reduce, dampen, and/or modulate an impact of data inputs, features, or model parameters within an algorithm performing an AI task. An attenuator can be configured to control an influence of elements that may otherwise skew or destabilize an algorithm performing an AI task. More specifically, an attenuator can be used to transform a bit representation produced by a model performing an AI task into an appropriate scale so that they can be compared to infer predictions from the model logic when performing the AI task. In this way, performance and robustness of an algorithm performing an AI task can be increased. A number of functions can be implemented as an attenuator. For example, a linear interpolation can be used as an attenuator. In a more specific example, the liner interpolation function can comprise:

$$f ( a , b ) = a * b$$

In these embodiments, a can comprise a bit representation produced by one or more operators (e.g., operator 202 (FIG. 2) and/or a bit representation of a number configured by an administrator. b can comprise a bit representation of a number determined by an identity of a model performing an AI task. In many embodiments, an attenuator (e.g., attenuator 206 (FIG. 2) can function similarly to a SLEW (e.g., SLEW 306 (FIG. 3)), but lack restrictions on the values that the attenuator interpolates between. For example, an attenuator can interpolate between 0 and 10 or 0 and 100.

Returning now to FIG. 2, attenuator 206 is shown. Attenuator 206 can invoke and/or call SLEW 207 and/or SLEW 306 (FIG. 3). For example, attenuator 206 can call one or more bitwise representations from a register 205. Bitwise representations can be attenuated by attenuator 206 (e.g., scaled, enhanced, and/or dampened) to modulate their influence on an AI task. Once sufficiently attenuated, the attenuator can pass an attenuated bitwise representation to a SLEW (e.g., SLEW 207 and/or SLEW 306 (FIG. 3)) for further processing.

Returning now to FIG. 1, in various embodiments, method 100 can comprise an activity 105 of converting a bitwise signal into one or more output values. In some embodiments, output values can comprise a non-integer value. Activity 105 can be similar to activity 102, above, but performed in reverse. For example, 0011 can be converted into a 3 and 0001 1000 1001 0011 0111 can be converted into 048 by reversing the procedures in activity 102. In various embodiments, an output value can comprise class values for a classification algorithm. For example, when a binary classifier is accelerated using an AI accelerator system, an output value (e.g., output value 209 (FIG. 2)) can comprise a positive class value (e.g., a score/likelihood for a positive classification) and/or a negative class value (e.g., a score/likelihood for a negative classification). In various embodiments, a greater value can represent an accelerated model's prediction. In some embodiments, a difference between the two outputs represents a confidence measure of the model. As another example, when a multi-class classifier is accelerated using an AI accelerator system, an output value can comprise a value for each class of the multi-class classifier (e.g., a score/likelihood for each classification). As a further example, when an allocation model is accelerated using an AI accelerator system, an output value can comprise an allocation percentage for each bin (e.g., a percentage of the whole that has been allocated to each allocation group).

In various embodiments, method 100 can comprise an activity 106 of facilitating training of a predictive algorithm. In various embodiments, training a machine learning algorithm can comprise estimating internal parameters of a model configured to make a prediction. In various embodiments, a predictive algorithm can be trained using labeled or unlabeled training data, otherwise known as a training dataset. In various embodiments, a training dataset can comprise all or a part of one or more output values. In the same or different embodiments, a pre-trained predictive algorithm can be used, and the pre-trained algorithm can be re-trained on the training data. In various embodiments, a machine learning algorithm can be iteratively trained in real time as new output values are generated. In several embodiments, due to a large amount of data needed to create and maintain a training data set, a machine learning model can use extensive data inputs to make a prediction. Due to these extensive data inputs, In various embodiments, creating, training, and/or using a machine learning algorithm configured to make a prediction cannot practically be performed in a mind of a human being.

In various embodiments, method 100 can comprise an activity 107 of facilitating using the trained predictive algorithm to make a prediction. When a predictive algorithm comprises a binary classifier, the prediction can comprise a positive classification or a negative classification into a group or bucket. When a predictive algorithm comprises a multi-class classification algorithm, the prediction can comprise a classification score for each class. When a predictive algorithm comprises a regression algorithm, the prediction can comprise a continuous output variable. When a predictive algorithm comprises a clustering algorithm, the prediction can predict a score for an input belonging to each cluster. When a predictive algorithm comprises a recommendation algorithm, the prediction can comprise a recommend next input. When a predictive algorithm comprises an allocation algorithm, the prediction can comprise an optimized allocation of resources. When a predictive algorithm comprises a ranking algorithm, the prediction can comprise a score used to order the inputs. When a predictive algorithm comprises an image recognition algorithm, the prediction can comprise a likelihood score for what is present in the image.

Turning ahead in the drawings, FIG. 4 illustrates a block diagram of a system 400 that can be employed for AI acceleration, as described in greater detail below. System 400 is merely exemplary and embodiments of the system are not limited to the embodiments presented herein. System 400 can be employed in many different embodiments or examples not specifically depicted or described herein. In various embodiments, certain elements or modules of system 400 can perform various procedures, processes, and/or activities. In these or other embodiments, the procedures, processes, and/or activities can be performed by other suitable elements or modules of system 400. Generally speaking, system 400 can be implemented with hardware and/or software. Part or all of the hardware and/or software implemented in system 400 can be conventional or part or all of the hardware and/or software can be customized (e.g., optimized) for implementing part or all of the functionality of system 400 described herein. When implemented as software, one or more elements of system 400 can be emulated (e.g., reproduced functionally and/or by action via software). For example, a virtual machine having one or more elements described below can be instantiated.

When implemented as hardware, one or more of the elements of system 400 can be coupled together using one or more chassis configured to hold one or more circuit boards and/or serial bus(es). These boards and buses allow the various elements of system 400 to communicate amongst each other to accomplish their intended purposes. While elements of system 400 are described below individually, each can also be integrated into one or more chassis, circuit boards, and/or buses of system 400. On the other hand, one or more elements of system 400 can also be removable (e.g., via a PCI slot on a motherboard and/or a USB port). One or mor elements of system 400 may also be integrated and/or embedded in a different machine or manufacture. Although specific constructions of boards and buses within system 400 are not shown, it should be understood that their construction can be tied to a form factor selected for system 400.

System 400 can take a number of different form factors based on its implementation. For example, system 400 can be implemented as a desktop computer, a laptop computer, a mobile device, and/or a wearable device as described herein. Further, system 400 can comprise a single computer, a single server, a cluster or collection of computers or servers, or a cloud of computers or servers. Typically, a cluster or collection of servers can be used when the demand on 400 exceeds the reasonable capability of a single server or computer, when a distributed structure for system 400 is desired, and/or when parallel computing is desired.

In various embodiments, system 400 can comprise a processor 401, a memory storage 402, an input device 403, a graphics adapter 404, a display device 405, a graphical user interface (GUI) 406, and/or a network adapter 407.

Processor 401 can comprise any type of computational circuit. For example, processor 401 can comprise a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, application specific integrated circuits (ASICs), a field programmable gate array (FPGA), a complex programmable logic device (FPLD), etc. Processor 401 can be configured to implement (e.g., run) computer instructions (e.g., program instructions) stored on memory devices in system 400. At least a portion of the program instructions, stored on these devices, can be suitable for carrying out at least part of the techniques and methods described herein. Architecture and/or design of processor 401 can be compliant with any of a variety of commercially distributed architecture families. For example, a processor can have a 32-bit (x86) architecture and/or a 64-bit (x86-64, IA64, and AMD64) architecture. Processor 401 can be configured to perform parallel computing in combination with other elements of system 400 and/or additional processors. Generally speaking, parallel computing can be seen as a technique where multiple elements of system 400 are used to perform calculations simultaneously. In this way, complex and repetitive tasks (e.g., training a predictive algorithm) can be performed faster and with less processing power than without parallel computing. In various embodiments, processor 401 can be reprogrammed at runtime. In this way, hardware operating as a processor that is optimal for a task and/or set of data (e.g., small data, big data, image data, time series data, classification, allocation, etc.) can be selected at runtime and programmed as an AI accelerator. Further, a firmware of processor 401 can be updated on demand over a lifecycle of the processor 401. In this way, AI accelerator algorithms and/or processor cores can be deployed to various cloud computing environments (e.g., Amazon Web Services) with minimal modification.

Memory storage 402 can comprise non-volatile memory (e.g., read only memory (ROM)) and/or volatile memory (e.g., random access memory (RAM)). The non-volatile memory can be removable and/or non-removable non-volatile memory. Meanwhile, RAM can comprise dynamic RAM (DRAM), static RAM (SRAM), or some other type of RAM. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), or some other type of ROM. Memory storage 402 can comprise non-transitory memory and/or transitory memory. All or a portion of memory storage 402 can be referred to as memory storage module(s) and/or memory storage device(s). Memory storage 402 can have a number of form factors when used in system 400. For example, memory storage 402 can comprise a magnetic disk hard drive, a solid state hard drive, a removable USB storage drive, a RAM chip, etc.

Memory storage 402 can be encoded with a wide variety of computer code configured to operate system 400. For example, portions of memory storage 402 can be encoded with a boot code sequence suitable for restoring system 400 to a functional state after a system reset. As another example, portions of memory storage 402 can comprise microcode such as a Basic Input-Output System (BIOS) operable with elements of system 400. Further, portions of the memory storage 402 can comprise an operating system (e.g., a software program that manages the hardware and software resources of a computer and/or a computer network). The BIOS can be configured to initialize and test components of system 400 and load the operating system. Meanwhile, the operating system can perform basic tasks such as, for example, controlling and allocating memory, prioritizing the processing of instructions, controlling input and output devices, facilitating networking, and/or managing files. Exemplary operating systems can comprise software within the Microsoft® Windows®, Mac OS®, Apple® iOS®, Google® Android®, UNIX®, and/or Linux® series of operating systems.

Input device 403 can be configured to allow a user to interact and/or control elements of system 400. A number of devices and be used as input device 403 alone or in combination. For example, input device 403 can comprise a keyboard, a mouse, a touch screen, a microphone, a camera, etc. Input device 403 can be coupled to other elements of system 400 in a number of ways. For example, input device 403 can be coupled via a Universal Serial Bus (USB) port in a wired and/or wireless manner or via a specialized port (e.g., a PS/2 port) depending on the specific device. User inputs through input device 403 can come in a number of forms. For example, when input device 403 comprises a microphone, user input can be received via voice commands and/or a speech to text algorithm. As another example, when input device 403 comprises a camera, user input can be received via bodily movements that are captured and interpreted by system 400.

Graphics adapter 404 can be configured to receive and/or generate one or more elements for display on display device 405. Exemplary embodiments of graphics adapter 404 can comprise devices within the NVIDIA® GeForce® and/or the AMD® RX® series of video cards. In various embodiments, a chipset present on graphics adapter 404 can be configured to perform similar, simultaneous computations in a manner more efficient than other chipsets. For example, rendering a 3D scene on graphics adapter 404 can involve repeated geometric calculations performed in parallel to generate the 3D scene. As another example, repeated mathematical calculations involved in training a predictive algorithm can be performed in parallel on graphics adapter 404 more efficiently than on processor 401. Display device 405 can receive and display signals from graphics adapter 404. A number of devices can be used as display device 405. For example, display device 405 can comprise a computer monitor, a television, a touch screen display, a heads up display (HUD) medium, etc.

In various embodiments, display device 405 can optionally display graphical user interface (GUI) 406. With regards to form, GUI 406 can comprise text and/or graphics (image) based user interfaces. For example, GUI 406 can comprise a heads up display (HUD). When GUI 406 comprises a HUD, GUI 406 can be projected onto a medium (e.g., glass, plastic, metal, etc.), displayed in midair as a hologram, and/or displayed on display device 405. GUI 406 can be color, black and white, and/or greyscale. GUI 406 can be implemented as an application running on a computer system. GUI 406 can also comprise a website accessed through a network (e.g., the Internet). For example, GUI 406 can comprise a website. When GUI 406 allows for modification and/or changes to one or more settings in system 400, it can be referred to as an administrative (e.g., back end) GUI. GUI 406 can also be displayed as or on a virtual reality (VR) and/or augmented reality (AR) system or display (e.g., a headset configured for VR, AR, and/or mixed reality displays). GUI 406 can receive a number of interactions from a user via input device 403. For example, an interaction with a GUI can comprise a click, a look, a selection, a grab, a view, a purchase, a bid, a swipe, a pinch, a reverse pinch, etc.

Network adapter 407 can be configured to connect system 400 to a computer network by wired communication (e.g., a wired network adapter) and/or wireless communication (e.g., a wireless network adapter). Network adapter 407 can be integrated into one or more chassis, circuit boards, and/or buses or be removable (e.g., via a PCI slot on a motherboard). For example, network adapter 407 can be implemented via one or more dedicated communication chips configured to receive various protocols of wired and/or wireless communications.

GPS 408 can comprise a chipset and/or module configured to communicate with a satellite based location system configured to provide location and time information. (e.g., GPS 230). This location and time information can then be used to determine a location of system 400. Audio output 409 can be configured to receive and/or generate one or more audio signals for play through a speaker. Exemplary audio outputs 409 can comprise an audio card.

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, In various embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, In various embodiments, the time delay can be less than approximately one second, two seconds, five seconds, or ten seconds.

As defined herein, “approximately” can, In various embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Although systems and methods for AI acceleration have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-4 may be modified, and that the foregoing discussion of certain of these embodiments does not necessarily represent a complete description of all possible embodiments. For example, one or more of the procedures, processes, or activities of FIG. 1 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory memories storing computing instructions configured to communicate with the one or more processors and cause the one or more processors to perform:
receiving one or more input values from an algorithm implementing a predictive algorithm;
converting each input value of the one or more input values into a bitwise representation of the input;
storing the bitwise representation of the input value in a register;
performing one or more bitwise operations on the bitwise representation of the input value to create a bitwise output;
converting the bitwise output into one or more output values;
facilitating training the predictive algorithm using the one or more output values; and
facilitating using the trained predictive algorithm to make a prediction.

2. The system of claim 1, wherein the converting the each value of the one or more input values into the bitwise representation comprises converting the each input value of the one or more input values into the bitwise representation of the input value using fixed point mathematics and without using a floating point representation.

3. The system of claim 1, wherein the one or more bitwise operations at least one of NAND, NOR, shift right, and shift left.

4. The system of claim 1, wherein the one or more second values comprises a positive class value or a negative class value from the algorithm implementing the predictive algorithm.

5. The system of claim 1 further comprising, after the storing in the register, modulating an influence of the one or more bitwise operations using one or more attenuators.

6. The system of claim 5, wherein the one or more attenuators implement a linear interpolation algorithm.

7. The system of claim 1, wherein the predictive algorithm comprises a binary classifier.

8. A method comprising:
receiving one or more input values from an algorithm implementing a predictive algorithm;
converting each input value of the one or more input values into a bitwise representation of the input value;
storing the bitwise representation of the input value in a register;
performing one or more bitwise operations on the bitwise representation of the input value to create a bitwise output;
converting the bitwise output into one or more output values;
facilitating training the predictive algorithm using the one or more output values; and
facilitating using the trained predictive algorithm to make a prediction.

9. The method of claim 8, wherein the converting the each value of the one or more input values into the bitwise representation comprises converting the each input value of the one or more input values into the bitwise representation of the input value using fixed point mathematics and without using a floating point representation.

10. The method of claim 8, wherein the one or more bitwise operations at least one of NAND, NOR, shift right, and shift left.

11. The method of claim 8, wherein the one or more second values comprises a positive class value or a negative class value from the algorithm implementing the predictive algorithm.

12. The method of claim 8 further comprising, after the storing in the register, modulating an influence of the one or more bitwise operations using one or more attenuators.

13. The method of claim 12, wherein the one or more attenuators, wherein the one or more attenuators implement a linear interpolation algorithm.

14. The method of claim 8, wherein the predictive algorithm comprises a binary classifier.

15. An application specific integrated circuit (ASIC) for training a predictive algorithm, the ASIC comprising:
one or more registers for storing one or more bitwise representations generated from one or more values received from an algorithm implementing the predictive algorithm, wherein the one or more bitwise representations are generated from the one or more values;
one or more operators for implementing one or more bitwise operations configured to create one or more bitwise outputs; and
one or more attenuators configured to modulate an influence of the one or more bitwise operations.

16. The ASIC of claim 15, wherein the one or more bitwise representations are generated from the one or more values without using fixed point mathematics and without using floating point mathematics.

17. The ASIC of claim 15, wherein the one or more bitwise operations at least one of NAND, NOR, shift right, and shift left.

18. The ASIC of claim 15, wherein the one or more second values comprises a positive class value or a negative class value from the algorithm implementing the predictive algorithm.

19. The ASIC of claim 15, wherein the one or more attenuators, wherein the one or more attenuators implement a linear interpolation algorithm.

20. The ASIC of claim 15, wherein the predictive algorithm comprises a binary classifier.
